(19) United States
(12) Patent Application Publication
(10) Pub. No.: US 2009/0281902 A1
(43) Pub. Date: Nov. 12, 2009

(54) Method of maintaining an exclusion database of intoxicated individuals by alcohol serving venues

(76) Inventor: John P. McNamara, North Stonington, CT (US)

Correspondence Address: Daniel N. Smith, 15 Church Street, Salem, MA, 01970, US

(21) Appl. No.: 12/151,489

(22) Filed: May 7, 2008

(51) Int. Cl. G06Q 10/00; G06Q 50/00

(52) U.S. Cl. 705/15

(57) ABSTRACT

Systems and methods are described that allow alcohol-serving vendors to verify whether a potential patron has been listed as intoxicated, violent or disruptive by another vendor using the system. Vendors obtain personal information from their patrons. If a patron becomes intoxicated, violent or disruptive, the vendor may input this personal information into a local workstation and upload it to a remote server for inclusion in local, regional and national databases of individuals that have been shut off or refused service by another vendor. Vendors may collect personal information of potential patrons as they attempt to purchase alcohol or enter a specific venue. Vendors using the system may input this personal information into a local workstation, and perform specific search queries of the databases to determine if patron has been recently listed as shut off or refused service by another vendor using the system.

### FIELD OF THE INVENTION

The present invention relates to methods for maintaining, updating and searching a private database through which alcohol-serving vendors may report intoxicated customers, violent customers, disruptive customers DUI multiple offenders or underage patrons that attempt to purchase alcohol. Vendors may search the database at local, regional and national levels by obtaining personal information from new patrons and searching the database before serving them alcohol or allowing them entry.

### BACKGROUND OF INVENTION

Any vendor that sells alcoholic beverages has to deal with the troublesome issue of intoxicated or violent patrons. Vendors can often determine which of their patrons are intoxicated if the patron purchases and consumes several alcoholic beverages in the presence of the vendor over a short period of time. However, vendors often cannot determine how many alcoholic beverages have been consumed by a new potential patron attempting to purchase his or her first alcoholic beverage from the vendor.

Vendors that stop serving or “shut off” alcoholic beverages to a patron cannot prevent the patron from going to another alcohol serving vendor. When a vendor stops serving or “shuts off” alcoholic beverages to a patron that patron is expected to stop consuming alcoholic beverages for at least an amount of time until the patron is no longer intoxicated. Unfortunately, many patrons do not stop consuming alcoholic beverages. Some patrons will go to another vendor and continue to consume alcoholic beverages. If these intoxicated patrons are served alcoholic beverages at the next vendor, then both the original vendor and the next vendor can be held liable for any damage or injury caused to another party by the intoxicated patron. There have been many lawsuits in which parties injured by intoxicated patrons have won judgments against multiple alcohol serving vendors for one liability incident involving the patron. In addition, alcohol serving vendors are required by many State and Federal laws to not serve alcoholic beverages to “known drunkards” or individuals under the age of 21.

Alcohol serving vendors lack an efficient means of communicating knowledge of intoxicated patrons, “DUI multiple offenders”, underage individuals attempting to purchase alcohol, or violent individuals to one another on a local, regional and national level.

Individuals intoxicated by alcohol present many different problems to alcohol serving vendors. Intoxicated individuals can cause disruptions at the vendor's place of business, by becoming belligerent with other patrons, harassing other patrons, vomiting or even falling unconscious. In addition, intoxicated individuals are often more prone to violent episodes with other patrons of the vendor or with other people outside the vendor's place of business.

To counteract the actions of intoxicated patrons, alcohol serving vendors must undertake additional expenses in running their business, such as increased security and janitorial staff. Many vendors may also face expensive fines, temporary or permanent business closure from state liquor control boards, liability, and increased liability insurance costs, for patrons that drive an automobile from the vendor's place of business under the influence of alcohol served by the vendor. The vendor may be liable to any third parties injured by the intoxicated individual driving an automobile under the influence of alcohol.

Previous inventions have disclosed methods of identifying individuals at points of sale or service to ensure legal compliance with Federal or State Law. For example, Mollett et al., U.S. Pat. No. 6,755,344, disclose a method for determining an age authorization at a point of sale for a restricted product. In addition, Sheppard et al., U.S. Pat. No. 6,679,425, disclose a process to determine whether a person is authorized to purchase restricted goods, such as alcohol. Lanier et al., U.S. Pat. No. 7,016,876, disclose a method of accessing a database identifying individuals listed on a gambler's exclusion list created and maintained by a state's gaming commission.

The previously disclosed methods do not disclose a vendor-maintained and vendor-updated database of potential liquor liability related individuals. The previously disclosed methods do not disclose a database that can be accessed and searched over a network by any alcohol serving vendors to verify that a potential patron has not been identified as intoxicated by another vendor or placed on the voluntary “Alcohol Exclusion Lists” within the network. The previously disclosed methods also do not disclose a database that can be updated with the personal profile of an intoxicated or violent individual at any time, by any alcohol serving vendor.

### SUMMARY OF THE INVENTION

There are additional features of the invention that will be described hereinafter and which will form the subject matter of the claims appended hereto. In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto. These together with other objects of the invention, along with the various features of novelty, which characterize the invention, are pointed out with particularity in the claims annexed to and forming a part of this disclosure.

For a better understanding of the invention, its operating advantages and the specific objects attained by its uses, reference should be made to the accompanying drawings and descriptive matter in which there are illustrated preferred embodiments of the invention. Other features and advantages of the present invention will become apparent from the following description of the preferred embodiment(s), taken in conjunction with the accompanying drawings, which illustrate, by way of example, the principles of the invention.

### BRIEF DESCRIPTION OF THE DRAWINGS

Advantages of the present invention will be apparent from the following detailed description of exemplary embodiments thereof, which description should be considered in conjunction with the accompanying drawings, in which:

FIG. 1 illustrates a flow chart that depicts one embodiment of the method of obtaining the personal information of a potential patron and comparing this information to a database containing a list of intoxicated individuals before serving the patron alcohol.

FIG. 2 illustrates a flow chart that depicts one embodiment of the method of obtaining the personal information of a potential patron and comparing this information to a database containing a list of intoxicated individuals before allowing the patron entry into an event or venue.

FIG. 3 illustrates a flow chart that depicts one embodiment of the method of reporting a patron to the system databases.

FIG. 4 illustrates a block diagram that depicts one embodiment of the system maintained, updated and searchable by alcohol serving vendors.

FIG. 5 illustrates an embodiment of the graphical user interface login screen displayed on the vendor's workstation.

FIG. 6 illustrates an embodiment of the graphical user interface function screen displayed on the vendor's workstation.

FIG. 7 illustrates an embodiment of the graphical user interface search screen displayed on the vendor's workstation.

FIG. 8 Illustrates an embodiment of the graphical user interface summary search results screen displayed on the vendor's workstation.

FIG. 9 Illustrates an embodiment of the graphical user interface summary profile results screen displayed on the vendor's workstation.

FIG. 10 Illustrates an embodiment of the graphical user interface full profile results screen displayed on the vendor's workstation.

FIG. 11 Illustrates an embodiment of the graphical user interface report a customer screen displayed on the vendor's workstation.

### DETAILED DESCRIPTION OF THE PREFERRED EMBODIMENTS

While several variations of the present invention have been illustrated by way of example in preferred or particular embodiments, it is apparent that further embodiments could be developed within the spirit and scope of the present invention, or the inventive concept thereof. However, it is to be expressly understood that such modifications and adaptations are within the spirit and scope of the present invention, and are inclusive, but not limited to the following appended claims as set forth.

The invention relates to a method of providing an alcohol serving vendor an electronic means of accessing a database identifying individuals listed on a patron exclusion list created by other alcohol serving vendors using said method. The invention achieves these objectives by providing a host server; local, regional and national databases residing within the host server; a means for uploading data from a plurality of workstations; a means for organizing all the uploaded data into the local, regional and national databases; a means for running specific search queries from a plurality of workstations on the databases; and a means for displaying the search query results on the workstations.

The subject invention is for BARCOP or Bars and Restaurant Cooperative Ownership Program, a system that allows alcohol vendors to verify whether a potential patron has been placed on an Alcohol Exclusion list and identified as intoxicated by another alcohol vendor on the system. The system is a silent, anonymous, national network of alcohol vendors that allows users to verify the sobriety of any potential patrons on the database maintained and administered by the network. Users may also enter the information of any of their patrons that are intoxicated.

Each member of the network may access a database maintained by alcohol vendors within the local area and nationally. Every member of the network may enter the personal information of an intoxicated patron by going through a network administrator and into the networked database. Once this information has been entered, all members who have access to the network may search the database using the personal information of any potential patrons. If a member indicates that a particular patron is intoxicated and has been “shut off” in the database, then this information is available to all other members. In one additional embodiment of the subject invention, members of the network may have notifications of local intoxicated patrons forwarded to them electronically without conducting an active search on the database.

The subject invention is a method for determining sobriety at a point of sale or other point of access control to an alcohol purchase. The point of sale of the alcohol may be a permanent physical location such as a bar, restaurant, grocery store, liquor store, stand, or other liquor retail outlets; or the point of sale may be a temporary location for specific events, such as concerts, fairs, and sporting events. The use of the terms “vendor”, “user” or “member” is intended to refer to any person who is using the method and is not meant to be limiting. The use of the terms “patron” or “potential patron” or “customer” or “individual” is intended to refer to any person whose personal information is being searched or reported to the system.

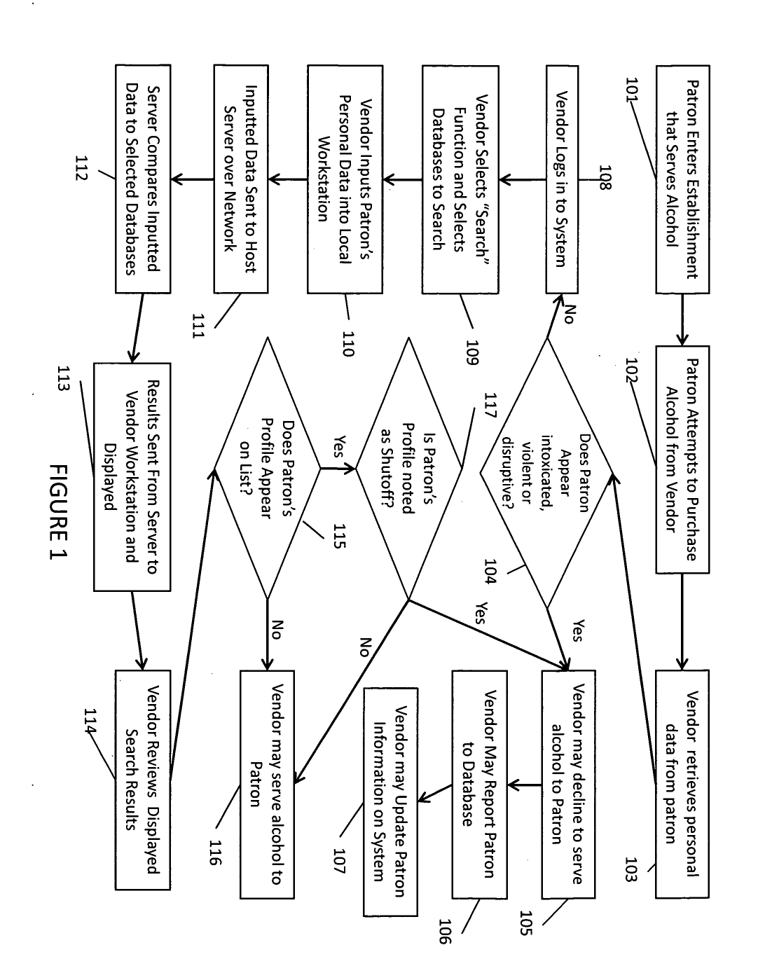

FIG. 1 illustrates a flow chart that depicts one embodiment of the method of the subject invention. In this embodiment, an alcohol serving vendor verifies that a potential patron has not been reported to any of the Alcohol Exclusion lists in the system databases before serving the patron alcohol.

A potential patron enters 101 an establishment, such as a restaurant or bar that serves alcoholic beverages. Once the patron attempts to purchase 102 Alcohol from the vendor, the vendor retrieves 103 personal data from the patron.

In one embodiment of the subject invention, this personal data may include, but not limited to: photo identification such as a driver license, the patron's full name, the patron's birth date, the patron's social security number, the patron's physical description and the patron's address. In another embodiment of the subject invention, the vendor may take a digital image of the potential patron using a cameraman scanner, or any other means known to those skilled in the art. In a further embodiment of the subject invention, personal information may include biometric information, including, but not limited to: a retinal scan, a fingerprint, a thumbprint, a palm print, a voice sample and a facial pattern.

If the vendor determines the patron is of legal age to purchase alcohol but, intoxicated, violent or disruptive 104, the vendor may decline service to the patron 105. The vendor may report 106 the patron to the database or update 107 a currently existing profile of the patron, as shown below. In alternative embodiments of the subject invention, vendors may verify the information of every potential patron or just potential patrons that appear intoxicated, violent or disruptive.

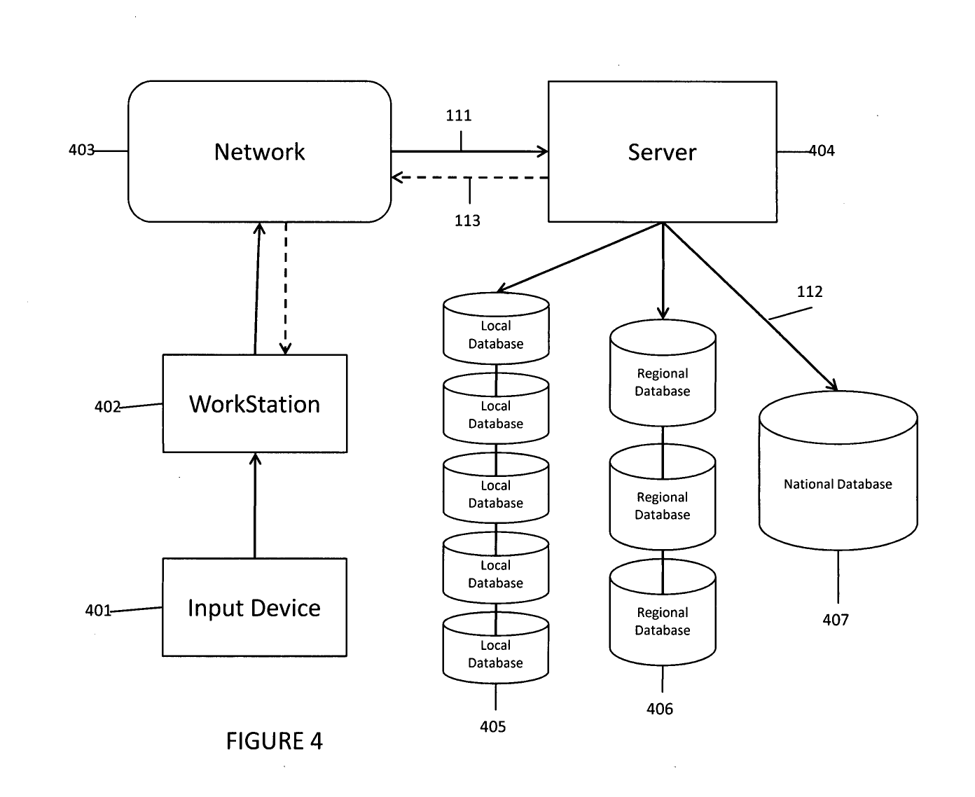

Once the vendor has retrieved the personal information from the patron, the vendor starts the system on a workstation 402 (as shown in FIG. 4) that is in communication with an Input/output (I/O) device 401. In one embodiment of the subject invention, the I/O device 401 may include a magnetic card reader, or another scanner through which a driver license with a magnetic strip may be swiped to input data contained on magnetic strip of the driver license into the workstation. In another embodiment of the subject invention, the I/O device 401 may include a barcode reader or another scanner through which a driver license with a barcode may be swiped or scanned to input data contained on the barcode of the driver license into the workstation. In a further embodiment of the subject invention, the vendor may enter the information contained on the driver license manually through a workstation keyboard.

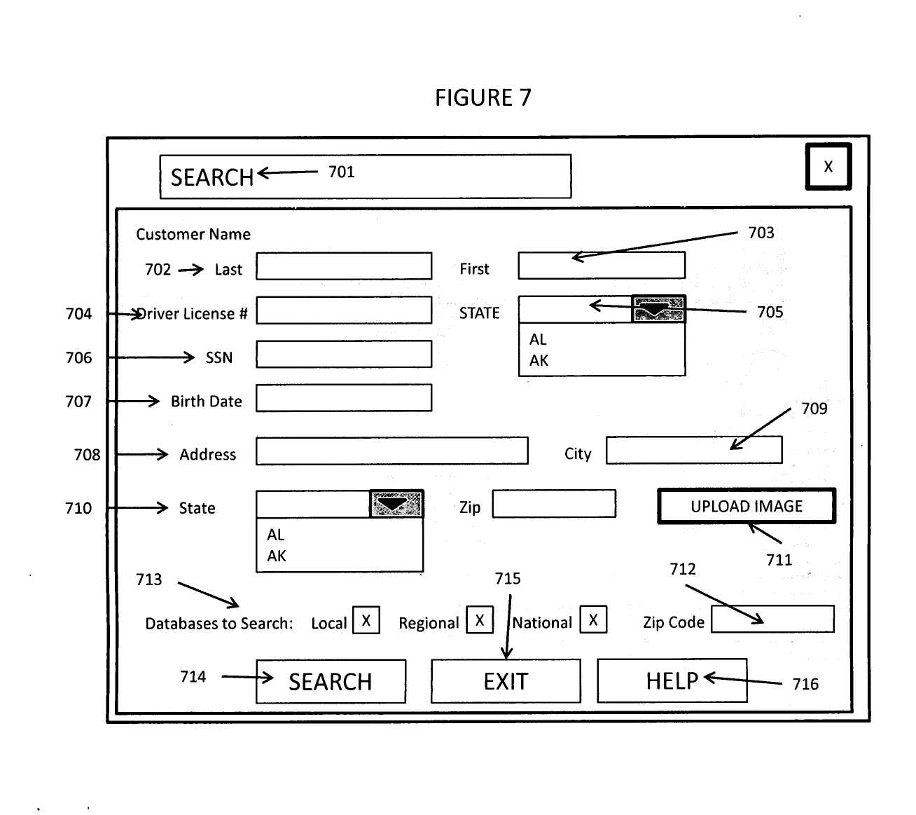

In other embodiments of the subject invention, the vendor may establish a registration system for patrons. For example, all recurring patrons may submit their personal information to the vendor in exchange for a vendor issued PIN or a magnetic striped card specifically produced for the vendor. In this embodiment, the vendor will maintain a workstation database of this personal information. The workstation 402 will include a software module that will retrieve this personal patron information and automatically load it into the search screen 701 (shown in FIG. 7) for a search on the system by swiping the specialized magnetic striped card or entering the patron's vendor based PIN using the I/O device 401.

In one embodiment of the subject invention, the workstation 402 may be a personal computer or a local server with a computer display connected to the Internet through a wired or wireless connection. In another embodiment of the subject invention, the workstation may be a cellular phone or a PDA that is connected to the Internet through a wired or wireless connection.

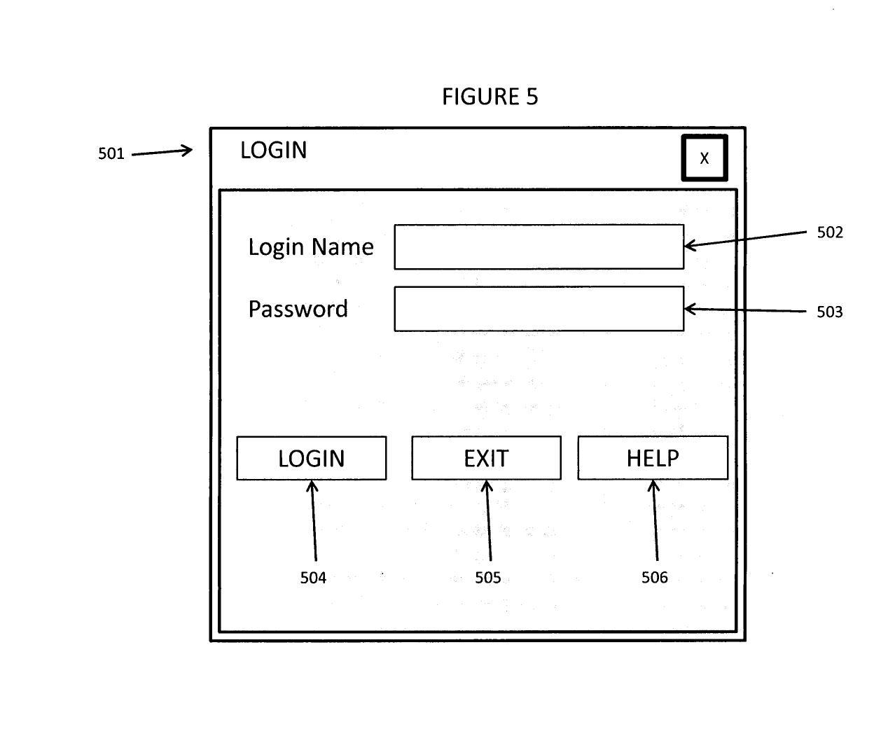

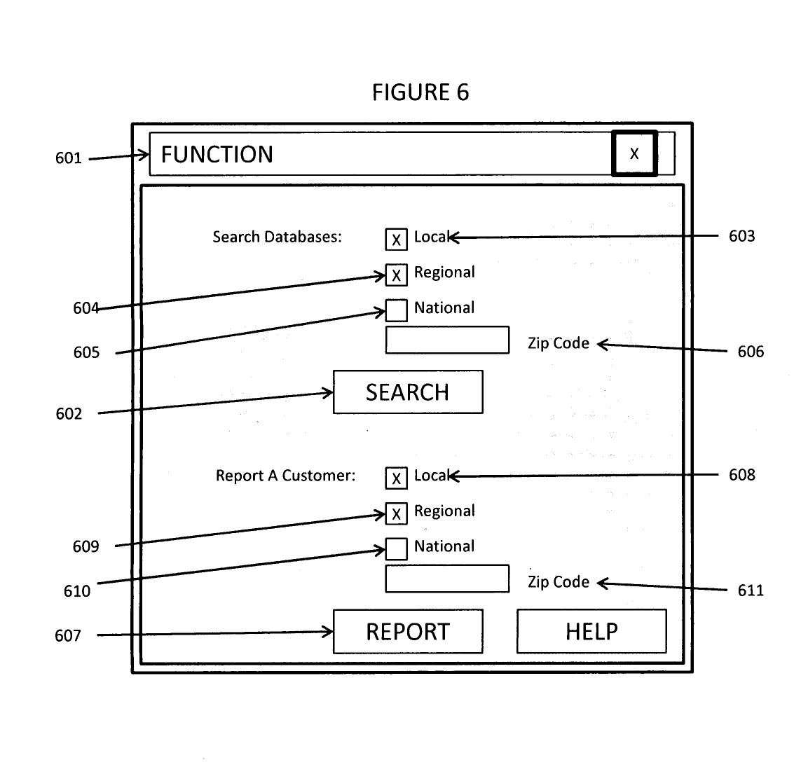

One embodiment of the first graphical user interface screen (GUI) to appear on the workstation is the login screen 501 (as shown in FIG. 5). Vendor logs in to the system 108 and the Function GUI screen 601 appears (an embodiment of which is shown in FIG. 6). Vendors may purchase various subscriptions to the system to gain login access. In another embodiment of the subject invention, the Host Server 404 runs authorization software, known to one with ordinary skill in the art, to verify the vendor's subscription to the system. The Vendor selects 109 the “SEARCH” button 602 on the Function screen 601 and selects the databases to search using data entry fields, 603, 604, 605 and 606. In one embodiment of the subject invention, the databases maintained by the system (as shown in FIG. 4) are local databases 405, regional databases 406 and a national database 407.

An embodiment of the next graphical user interface screen to appear on the workstation is the search screen 701 (as shown in FIG. 7). The vendor inputs 110 the personal information into the search screen 701 using data entry fields 702, 703, 704, 705, 706, 707, 708, 709, 710 and 711. In another embodiment of the subject invention, the vendor may enter the zip code of the vendor's establishment 712. The network provides the vendor with a list of all people that have been shut off in the vendor's zip code and surrounding zip codes. Each 24 hour period will contain a new list since the databases are constantly updated by the vendors using the system. In one embodiment of the subject invention, all updates to the databases are in real time.

Once the vendor has inputted the personal information of the potential patron into the workstation 402, the system sends 111 the information to a host server 404. The Host Server 404 compares 112 the inputted data to the selected databases. In one embodiment of the subject invention, the database may be searched according to personal information including, but not limited to: last name, first name, birth date, social security number, driver's license number, physical description, address and image.

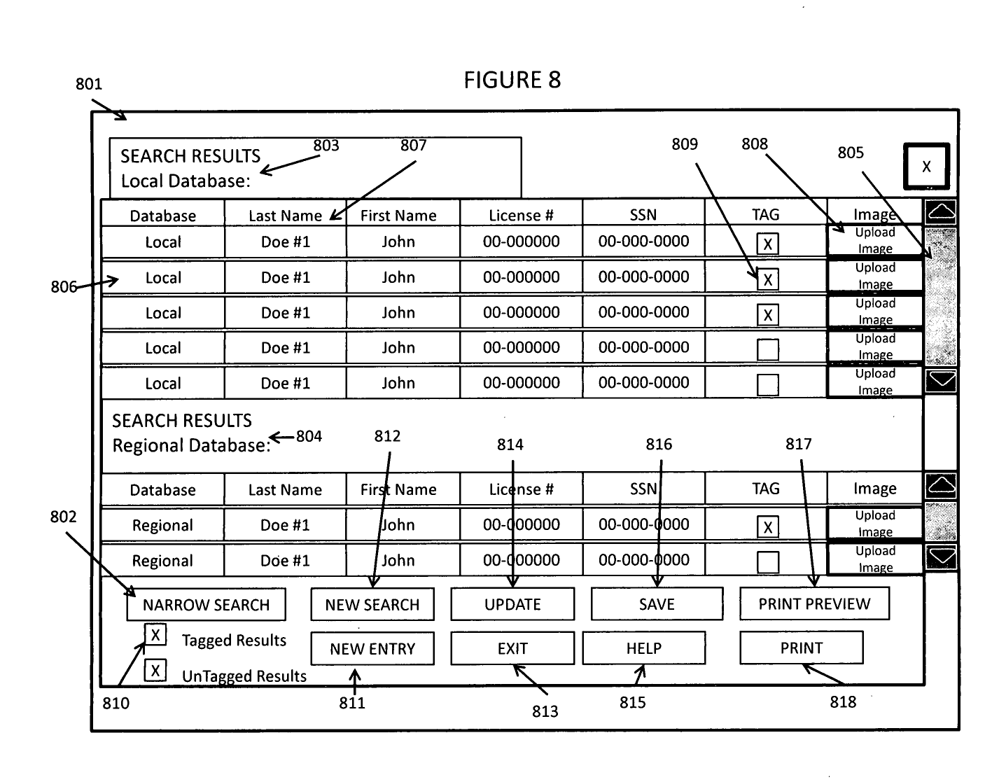

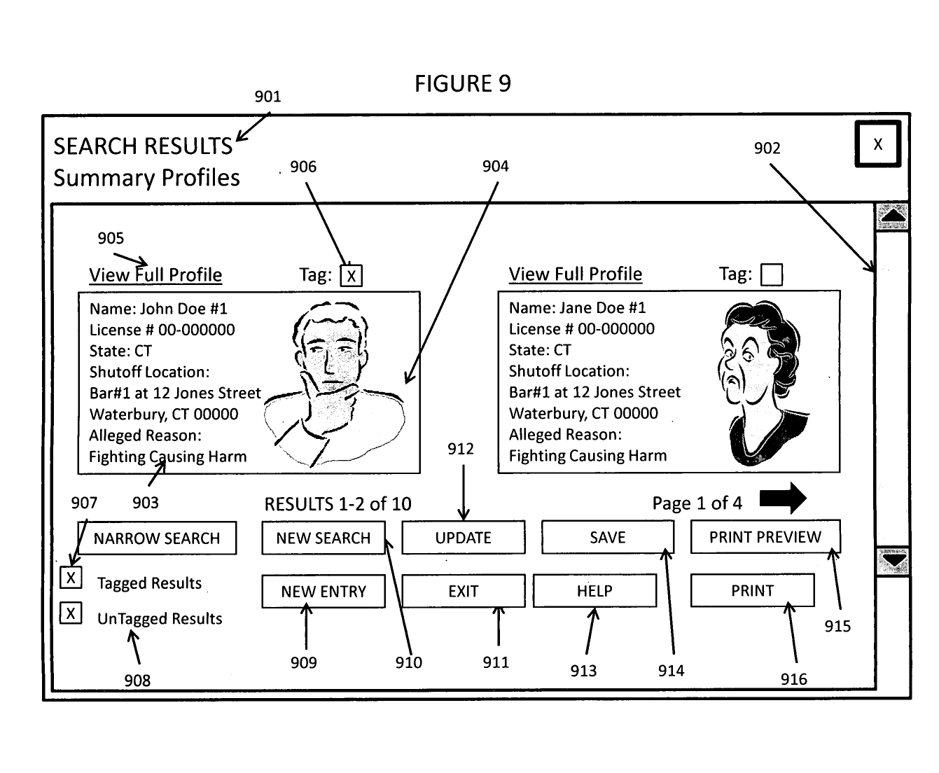

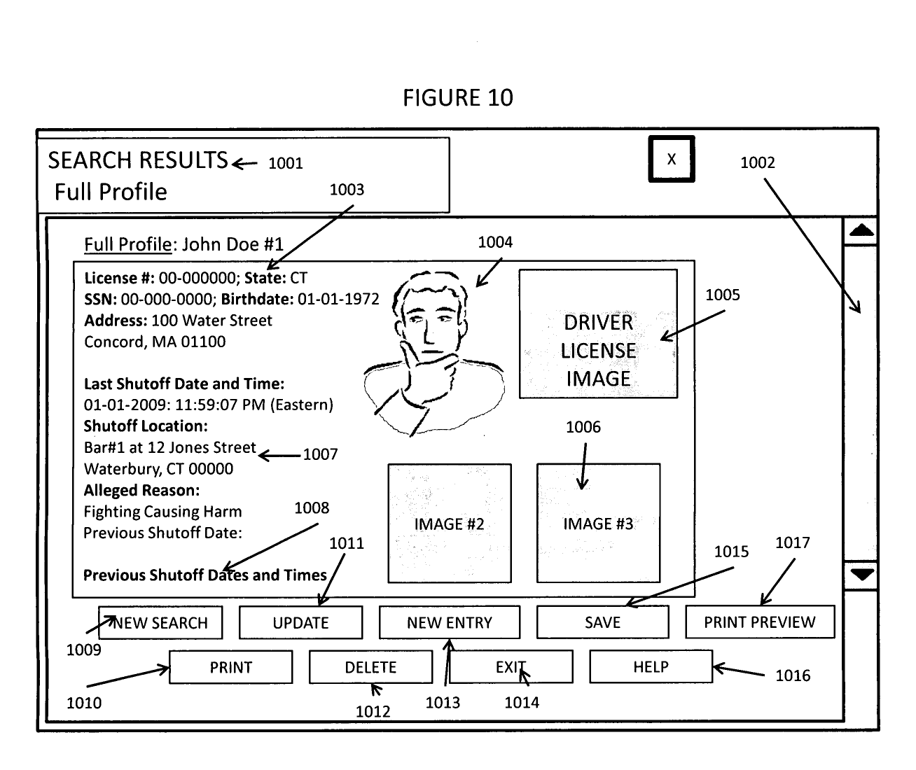

The search results are sent 113 from the Host Server 404 and displayed on the workstation 402. The vendor reviews 114 the search results displayed on the workstation 402. An embodiment of the search results screen 801 is shown in FIG. 8. The vendor may narrow the search results by clicking the “NARROW SEARCH” button 802 on the search results screen 801 to view a summary profile result screen 901 (an embodiment is shown in FIG. 9) and full profile result screen 1001 (an embodiment is shown in FIG. 10) to find 115 the potential patron's profile.

If the patron's profile does not appear in the search results, the vendor may serve 116 alcohol to the patron. If the patron's profile does appear in the search results, the vendor will review the profile to determine 117 if the patron's profile is noted as shutoff for the day. If the patron's profile is listed as shutoff, the vendor may decline to serve 105 alcohol to the patron.

In alternative embodiments of the subject invention, even if the patron's profile is not noted as shutoff, the vendor may view previous shutoff days on the patron's full profile screen 1001 and decline to serve 105 alcohol to the patron.

Once the vendor has determined if the patron is to be served alcohol, the vendor may report the patron's profile to the database 106 or update a currently existing profile of the patron 107 in case such authorization needs to be confirmed at a later time.

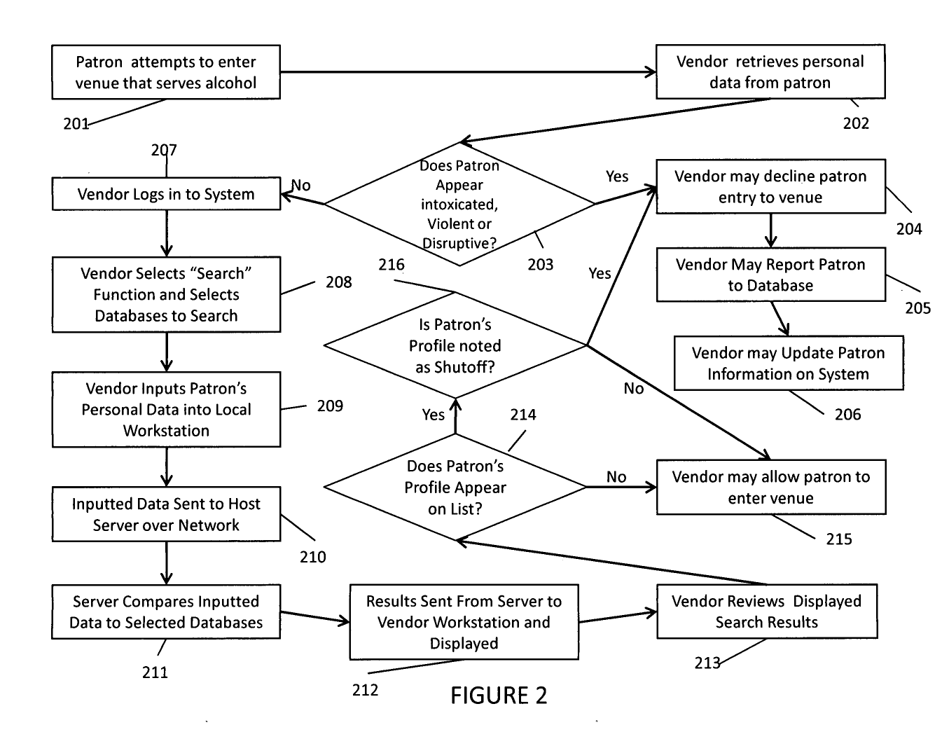

FIG. 2 illustrates a flow chart that depicts another embodiment of the method of the subject invention. Is this embodiment, an alcohol serving vendor verifies that a potential patron has not been reported and listed in the system databases before allowing patron entry into an event or venue. A potential patron attempts to enter 202 a venue, such as a restaurant, a bar, a dance club, a sporting event or a concert that serves alcoholic beverages. The vendor retrieves 202 personal data from the patron.

If the vendor determines the patron is intoxicated, violent or disruptive 203, the vendor may decline service to the patron 204. The vendor may report 205 the patron to the database or update 206 a currently existing profile of the patron. In alternative embodiments of the subject invention, vendors may verify the personal information of every patron that attempts to enter the venue on the system.

Once the vendor has retrieved the personal information from the patron, the vendor starts the system on a workstation 402 that is in communication with an Input/output (I/O) device 401. Vendor logs in to the system 207. The Vendor selects 208 the “SEARCH” button 602 on the Function screen 601 and selects the databases to search using data entry fields, 603, 604, 605 and 606. The vendor inputs 209 the personal information into the search screen 701.

Once the vendor has inputted the personal information of the potential patron into the workstation 402 the system sends 210 the information to a host server 404. The Host Server 404 compares 211 the inputted data to the selected databases.

The search results are sent 212 from the Host Server 404 and displayed on the workstation 402. The vendor reviews 213 the search results displayed on the workstation 402. The vendor may narrow the search results by clicking the “NARROW SEARCH” button 802 on the search results screen 801 to view a summary profile result screen 901 (an embodiment is shown in FIG. 9) and a full profile result screen 1001 (an embodiment is shown in FIG. 10) to find 214 the potential patron's profile.

If the patron's profile does not appear in the search results, the vendor may 215 allow patron to enter the venue. If the patron's profile does appear in the search results, the vendor will review the profile to determine 216 if the patron's profile is noted as shutoff for the day. If the patron's profile is listed as shutoff, the vendor may decline entry to the venue 204. Once the vendor has allowed the patron to enter the venue 215, the vendor may report the patron's profile to the database 205 or update a currently existing profile of the patron 206 in case such authorization needs to be confirmed at a later time.

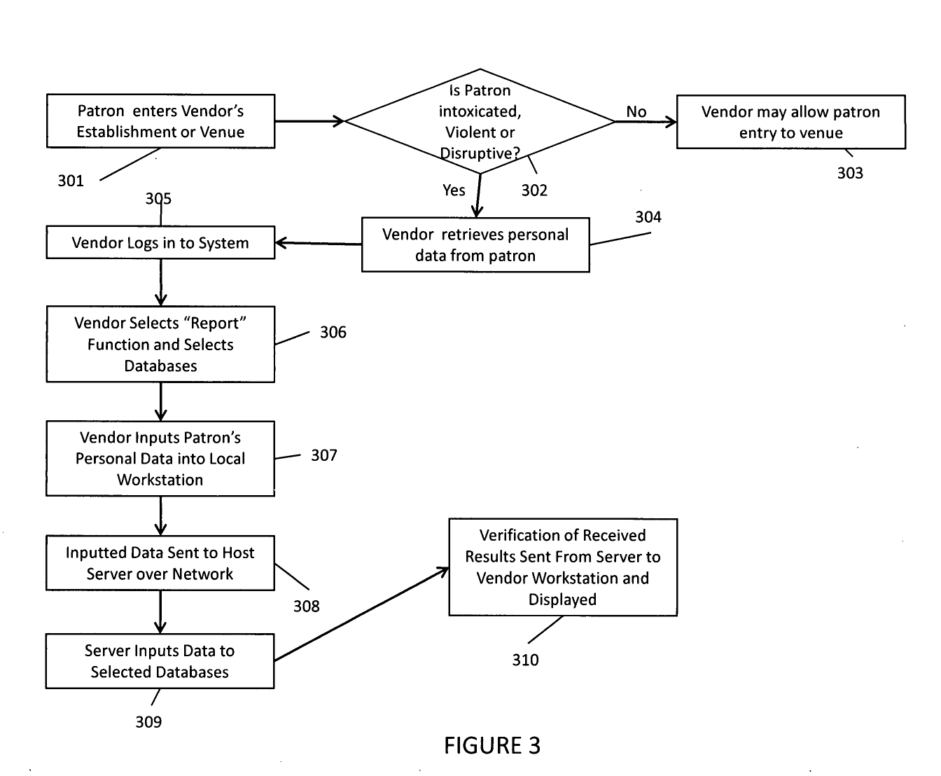

FIG. 3 illustrates a flow chart that depicts one embodiment of the method of reporting a patron to the system databases.

A potential patron has entered or attempted to enter 301 an establishment or a venue that serves alcoholic beverages. If the patron does not appear intoxicated, violent or disruptive 302, the vendor will allow 303 the patron to enter the venue. If the vendor determines the patron is intoxicated, violent or disruptive 302, the vendor retrieves 304 personal data from the patron. Once the vendor has retrieved the personal information from the patron, the vendor starts the system on a workstation 402 (as shown in FIG. 4) that is in communication with an Input/output (I/O) device 401.

Vendor logs in to the system 305 and the Function GUI screen 601 appears (an embodiment of which is shown in FIG. 6). The Vendor clicks 306 the “REPORT” button 607 on the Function screen 601 and selects the databases to report to using data entry fields, 608, 609, 610 and 611.

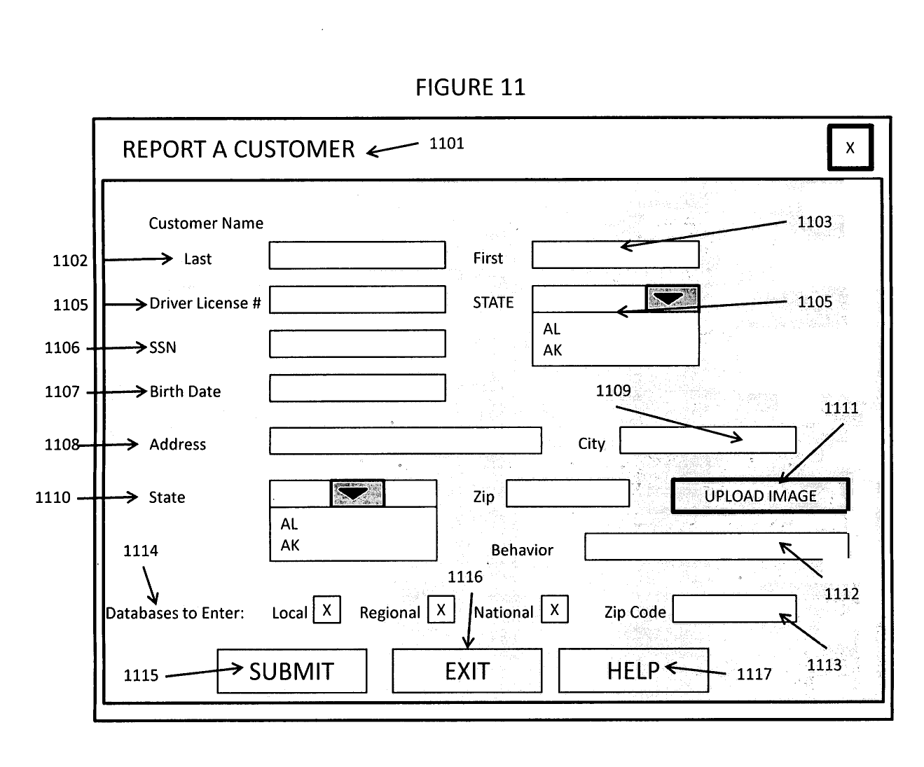

An embodiment of the next graphical user interface screen (GUI) to appear on the workstation is the Report a Customer screen 1101 (as shown in FIG. 11). The vendor inputs 307 the personal information into the Report a Customer screen 1101 using data entry fields 1102, 1103, 1104, 1105, 1106, 1107, 1108, 1109, 1110, 1111 and 1112. In another embodiment of the subject invention, the vendor may enter the zip code of the vendor's establishment 1113.

Once the vendor has inputted the personal information of the potential patron into the workstation 402 the system sends 308 the information to a host server 404. The Host Server 404 inputs 309 the data in the selected databases. A verification of received results is sent 310 from the Host Server 404 to the workstation 402.

In another embodiment of the subject invention, individuals prosecuted for alcohol related crimes, such as DUIs, may agree to have their profiles added to the Alcohol Exclusion lists for a given amount of time as part of a plea agreement or sentence. In another embodiment of the subject invention, individuals may agree to have their profiles automatically listed as “shut off” on network by their employers at given intervals when the individual must remain sober for work. In a further embodiment of the subject invention, individuals may voluntary add their names to the Alcohol Exclusion lists as part of an alcohol abuse program.

FIG. 4 illustrates a block diagram that depicts one embodiment of the system maintained by alcohol serving vendors. Once a vendor has retrieved the personal information from the patron, the vendor starts the system on a workstation 402 that is in communication with an Input/output (I/O) device 401. The vendor inputs 110 the personal information. Once the vendor has inputted the personal information of the potential patron into the workstation 402 the system sends 111 the information to a host server 404 through a network 403. The Host Server 404 compares 112 the inputted data to the local databases 405, regional databases 406 and a national database 407. The search results are sent 113 from the Host Server 404 and displayed on the workstation 402. The vendor reviews 114 the search results displayed on the workstation 402.

In a further embodiment of the subject invention, the vendor may maintain local databases on their own workstations for faster searching. In another embodiment of the subject invention, the workstation can be installed with a software module the retrieves and displays local database lists of shutoff patrons automatically generated by the Host Server in real-time.

In one embodiment of the subject invention, the graphical user interface screens for inputting and viewing data on the system, described below, may be installed as one or more software modules on the workstation. In another embodiment of the subject invention, the graphical user interface screens may be accessed over the Internet through an Interactive website FIG. 5 illustrates an embodiment of the graphical user interface login screen 501 displayed on the vendor's workstation. This GUI screen contains data entry fields 502 for a log in name and 503 for a log in password. This GUI screen also contains a “LOGIN” button 504 to begin the log in process and display the Function GUI screen 601 when clicked by a vendor; an “EXIT” button 505 that exits the system when clicked by a vendor; and a “HELP” button 506 that displays a GUI help screen (not shown) when clicked by a vendor. In another embodiment of the subject invention, the “EXIT” button 505 may be labeled as a “LOG OUT.”

FIG. 6 illustrates an embodiment of the graphical user interface Function screen 601 displayed on the vendor's workstation. This GUI screen contains data entry field 603 for marking a request for the Host Server to search the local databases. This GUI screen also contains data entry field 604 for marking a request for the Host Server to search the regional databases. This GUI screen further contains data entry field 605 for marking a request for the Host Server to search the national database. This GUI screen even further contains data entry field 606 for entering a zip code for the Host Server to search. This GUI screen also contains a “SEARCH” button 602 to display the search screen 701 when clicked by a vendor.

FIG. 6 also illustrates data entry field 608 for marking a request for the Host Server to add a profile to the local databases. This GUI screen also contains data entry field 609 for marking a request for the Host Server to add a profile to the regional databases. This GUI screen further contains data entry field 610 for marking a request for the Host Server to add a profile to the national database. This GUI screen even further contains data entry field 611 to add a profile to a zip code. This GUI screen also contains a “REPORT” button 607 that, when clicked, displays the Report a Customer screen 1101.

FIG. 7 illustrates an embodiment of the graphical user interface search screen 701 displayed on the vendor's workstation. This GUI screen contains data entry fields 702 for a last name, 703 for a first name, 704 for a Driver License Number, 705 for a Driver License Issued State, 706 for a Social Security Number, 707 for a Birth date, 708 for an Address, 709 for a City of Domicile and 710 for a State of Domicile. The GUI screen also contains an “IMAGE” button 711 for displaying a separate window (not shown, but know to those with ordinary skill in the art) for uploading a digital image to be searched on the system databases. This GUI screen contains data entry fields 713 for marking a request for the Host Server to search the local, regional and national databases. This GUI screen even further contains data entry field 712 for entering a zip code for the Host Server to search. This GUI screen also contains a “SEARCH” button 714 that transmits the search query to the Host Server 404 when clicked by a vendor. This GUI screen also contains an “EXIT” button 505 that exits the system when clicked by a vendor, and a “HELP” button 506 that displays a GUI help screen (not shown) when clicked by a vendor. In another embodiment of the subject invention, the GUI search screen 701 may contain data entry fields for a State ID number and Issuing State (not shown).

FIG. 8 Illustrates an embodiment of the graphical user interface summary search results screen 801 displayed on the vendor's workstation. This GUI screen displays scrollable 805 Local Database results 803 from the search, Regional Database results 804 from the search and National Database results from the search (Not Shown).

The Search results 806 are organized by individual profiles. Headers 807 categorize the separate personal information contained within the profiles. Each profile also contains an “IMAGE” button 808 for displaying the image of the profile in a separate window (not shown, but know to those with ordinary skill in the art). This GUI screen contains data entry fields 809 or Tags for marking those search results that the vendor wants to narrow or review further.

A vendor may Tag 809 profiles and display only the tagged profiles on the search results screen 801 by clicking the “NARROW SEARCH” button 802. In another embodiment of the subject invention, the GUI screen contains data entry fields 810 for marking whether a limited display search results screen 801 should include only tagged profiles or only untagged profiles.

In one embodiment of the subject invention, a vendor may Tag 809 profiles and update only the tagged profiles by clicking the “UPDATE” button 814. A vendor may save these search results by clicking the “SAVE” button 816. In another embodiment of the subject invention, a vendor may Tag 809 profiles and preview only the tagged profiles by clicking the “PRINT PREVIEW” button 817. In a further embodiment of the subject invention, a vendor may Tag 809 profiles and print only the tagged profiles by clicking the “PRINT” button 818. This GUI screen also contains an “EXIT” button 813 that exits the system when clicked by a vendor, and a “HELP” button 814 that displays a GUI help screen (not shown) when clicked by a vendor.

The vendor may also conduct a new search by clicking the “NEW SEARCH” button 812 which displays the graphical user interface search screen 701. The vendor may also report a new profile to the Host Server 404 by clicking the “NEW ENTRY” button 811 which displays the graphical user interface Report a Customer screen 1101. In another embodiment of the subject invention, a vendor may Tag 809 a profile and click the “NEW ENTRY” button 811 which displays the Report a Customer screen 1101 with the profile's information already in the data fields of the Report a Customer screen 1101.

FIG. 9 Illustrates an embodiment of the graphical user interface summary profile results screen 901 displayed on the vendor's workstation. This GUI screen displays scrollable 902 summary profile results 903 from the search in which each profile may contain an image 904.

The summary profile results 903 have a “View Full Profile” link 905 that displays the full profile screen 1001 of a profile when clicked by a vendor. This GUI screen contains data entry fields 906 or Tags for marking those search results that the vendor wants to narrow or review further.

A vendor may Tag 906 profiles and display only the tagged profiles on the summary profile results screen 901 by clicking the “NARROW SEARCH” button 907. In another embodiment of the subject invention, the GUI screen contains data entry fields 908 for marking whether a limited summary profile results screen 901 should include only tagged profiles or only untagged profiles.

In one embodiment of the subject invention, a vendor may Tag 906 profiles and update only the tagged profiles by clicking the “UPDATE” button 912. A vendor may save these search results by clicking the “SAVE” button 914. In another embodiment of the subject invention, a vendor may Tag 906 profiles and preview only the tagged profiles by clicking the “PRINT PREVIEW” button 915. In a further embodiment of the subject invention, a vendor may Tag 906 profiles and print only the tagged profiles by clicking the “PRINT” button 916. This GUI screen also contains an “EXIT” button 911 that exits the system when clicked by a vendor, and a “HELP” button 913 that displays a GUI help screen (not shown) when clicked by a vendor.

The vendor may also conduct a new search by clicking the “NEW SEARCH” button 910 which displays the graphical user interface search screen 701. The vendor may also report a new profile to the Host Server 404 by clicking the “NEW ENTRY” button 909 which displays the graphical user interface Report a Customer screen 1101. In another embodiment of the subject invention, a vendor may Tag 906 a profile and click the “NEW ENTRY” button 909 which displays the Report a Customer screen 1101 with the profile's information already in the data fields of the Report a Customer screen 1101.

FIG. 10 Illustrates an embodiment of the graphical user interface full profile results screen 1001 displayed on the vendor's workstation. This GUI screen displays scrollable 1002 full profile results 1003 from the search that contain an image 1004, a driver license image 1005, and potential a third image 1006 of the profile. The full profile also contains the most recent shutoff location and alleged reason for the shutoff 1007. The full profile further contains previous shutoff locations and alleged reasons 1008.

In one embodiment of the subject invention, a vendor may update the full profile results 1003 by clicking the “UPDATE” button 1011. A vendor may also save the full profile results 1003 by clicking the “SAVE” button 1015. In another embodiment of the subject invention, a vendor may preview the full profile results by clicking the “PRINT PREVIEW” button 1017. In a further embodiment of the subject invention, a vendor may print the full profile results 1003 by clicking the “PRINT” button 1010. In a further embodiment of the subject invention, a vendor may delete the full profile results 1003 by clicking the “DELETE” button 1012. This GUI screen also contains an “EXIT” button 1014 that exits the system when clicked by a vendor, and a “HELP” button 1016 that displays a GUI help screen (not shown) when clicked by a vendor.

The vendor may also conduct a new search by clicking the “NEW SEARCH” button 1009 which displays the graphical user interface search screen 701. The vendor may also report a new profile by clicking the “NEW ENTRY” button 1013 which displays the graphical user interface Report a Customer screen 1101.

In another embodiment of the subject invention, the graphical user interface full profile results screen 1001 displayed on the vendor's workstation may also contain video clips of the patron (not shown).

FIG. 11 Illustrates an embodiment of the graphical user interface Report a Customer screen 1101 displayed on the vendor's workstation. In order to keep the network databases constantly updated, vendors must daily report intoxicated, new violent or disruptive patrons to the network database as well as voluntary exclusions.

This GUI screen contains data entry fields 1102 for a last name, 1103 for a first name, 1104 for a Driver License Number, 1105 for a Driver License Issued State, 1106 for a Social Security Number, 1107 for a Birth date, 1108 for an Address, 1109 for a City of Domicile and 1110 for a State of Domicile. The GUI screen also contains an “IMAGE” button 1111 for displaying a separate window (not shown, but know to those with ordinary skill in the art) for uploading a digital image to be uploaded into the profile. In another embodiment of the subject invention, the GUI Report a Customer screen 1101 may contain data entry fields for a State ID number and Issuing State (not shown).

This GUI screen also contains a data entry field 1112 for entering the specific alleged behavior that resulted in the vendor shutting off the patron.

This GUI screen contains data entry fields 1114 for marking a request for the Host Server to upload the profile to the local, regional and national databases. This GUI screen even further contains data entry field 1113 for entering a zip code for the Host Server to upload the profile to. This GUI screen also contains a “SUBMIT” button 1115 that, when clicked by a vendor, transmits the information to the Host Server 404 to be uploaded to the system databases. This GUI screen also contains an “EXIT” button 1116 that exits the system when clicked by a vendor, and a “HELP” button 1117 that displays a GUI help screen (not shown) when clicked by a vendor.

What is claimed is:

1. A method of providing an alcohol serving vendor an electronic means of accessing a database identifying individuals listed on a patron exclusion list created by other alcohol serving vendors using the database comprising:
a) providing a host server;
b) providing a plurality of local, regional and national databases containing the patron exclusion list on the host server, wherein the patron exclusion list is a list of individual profiles;
c) a means for organizing uploaded data into the plurality of local, regional and national databases;
d) a means for running a specific search query from a plurality of workstations on the plurality of local, regional and national databases; and
e) a means for displaying the specific search query results on the plurality of workstations.

2. The method of claim 1, wherein the individual profiles comprise personal information selected from the group consisting of name, address, birth date, social security number, image and driver license number.

3. A process for controlling alcohol sales, comprising:
a) identifying a patron attempting to purchase alcohol;
b) obtaining personal information from the patron;
c) using an input/output device to input the personal information into a workstation;
d) uploading the inputted personal information from the workstation to a remote server, wherein the remote server comprises a list of individual profiles, further wherein each individual profile comprises a plurality of personal identifiers, wherein each individual profile may further comprise either a first behavior identifier which indicates that the individual identified by the individual profile was refused purchase of an alcoholic beverage or a second behavior identifier which indicates that the individual identified by the individual profile was not refused purchase of an alcoholic beverage;
e) using a software module on the remote server to compare the inputted personal information to the plurality of personal identifiers in the list of individual profiles to produce a list of identified profiles, wherein each identified profile contains at least one personal identifier that matches the inputted personal information;
f) transmitting the list of identified profiles to the workstation;
g) reviewing the list of identified profiles to determine if one of the identified profiles is an identified profile of the patron;
h) determining if the identified profile of the patron contains the first behavior identifier; and
i) taking preventative action if the identified profile of the patron contains the first behavior identifier

4. The method of claim 3, wherein the first behavior identifier further comprises a geographic identifier.

5. The method of claim 4, wherein the geographic identifier is selected from the group consisting of zip code, city, township, county and State.

6. The method of claim 3, wherein the first behavior identifier indicates a behavior selected from the group consisting of violent behavior, intoxicated behavior, and disruptive behavior.

7. The method of claim 3, wherein the personal information is selected from the group consisting of name, address, birth date, social security number, image and driver license number.

8. The method of claim 3, wherein each personal identifier is selected from the group consisting of name, address, birth date, social security number, image and driver license number.

9. The method of claim 3, wherein the preventative action comprises refusing to sell alcohol to the patron.

10. The method of claim 3, wherein the preventative action comprises notifying security personnel.

11. The method of claim 3, wherein the preventative action comprises refusing patron entry into a venue.

12. The method of claim 11, wherein the venue is selected from the group consisting of a concert hall, a stadium, a bar, a restaurant, a dance club, a fair ground, a circus tent, a movie theater, a casino, a racetrack, a park, an ice arena, a gymnasium, a school, a gold course, an exercise facility and a hall.

13. The process of claim 3, wherein the step of obtaining personal information from the patron comprises receiving information entered using at least one of the methods comprising: scanning in, reading electronically, keying in manually, and inputting orally.

14. A method for submitting a patron's profile to a database identifying individuals listed as refused an alcohol sale by alcohol serving vendors, comprising:
a) obtaining personal information from the patron;
b) using an input/output device to input the personal information into a workstation;
c) uploading the inputted personal information from the workstation to a remote server, wherein the remote server comprises a list of individual profiles, further wherein each individual profile comprises a plurality of personal identifiers, wherein each individual profile may further comprise either a first behavior identifier which indicates that the individual identified by the individual profile was refused purchase of an alcoholic beverage or a second behavior identifier which indicates that the individual identified by the individual profile was not refused purchase of an alcoholic beverage;
d) using a software module on the remote server to create an individual profile for the patron with the plurality of personal identifiers that matches the inputted personal information;
e) using the software module to add a first behavior identifier which indicates that the individual identified by the individual profile was refused purchase of an alcoholic beverage to the individual profile for the patron;
f) using the software module to add individual profile for the patron to list of individual profiles; and
g) transmitting a display of the individual profile for the patron and a confirmation that the individual profile for the patron was added to the list of individual profiles to the workstation.

15. The method of claim 14, wherein the first behavior identifier further comprises a geographic identifier.

16. The method of claim 15, wherein the geographic identifier is selected from the group consisting of zip code, city, township, county and State.

17. The method of claim 14, wherein the first behavior identifier indicates a behavior selected from the group consisting of violent behavior, intoxicated behavior, and disruptive behavior.

18. The method of claim 14, wherein the personal information is selected from the group consisting of name, address, birth date, social security number, image and driver license number.

19. The method of claim 14, wherein each personal identifier is selected from the group consisting of name, address, birth date, social security number, image and driver license number.

20. The process of claim 3, wherein the step of obtaining personal information from the patron comprises receiving information entered using at least one of the methods comprising: scanning in, reading electronically, keying in manually, and inputting orally.
